(19) United States
(12) Patent Application Publication
(10) Pub. No.: US 2011/0277862 A1
(43) Pub. Date: Nov. 17, 2011

(54) MULTI-WAY REVERSING VALVE

(75) Inventor: Takeshi Kannoo, Tokyo (JP)

(73) Assignee: Fujikoki Corporation, Tokyo (JP)

(21) Appl. No.: 13/105,438

(22) Filed: May 11, 2011

(30) Foreign Application Priority Data
May 12, 2010 (JP) 2010110285

(51) Int. Cl. F16K 11/07

(52) U.S. Cl. 137/625.15; 137/625.46

(57) ABSTRACT

There is provided a multi-way reversing valve capable of preventing the obstruction of fluid circulation between in/out ports and a valve chamber without causing an increase in size. There is provided a laterally protruding part and a base end-side overhang part. The laterally protruding part protrudes significantly outward in the radial direction from rotational axis line O. The base end-side overhang part is continuous with the laterally protruding part, protrudes in the opposite direction to the protruding direction of the laterally protruding part, and is semi-circular or semi-elliptical in plan view. A surface of the laterally protruding part on the valve seat member-side is taken to be a reference surface. An amount corresponding to a predetermined thickness is removed from the reference surface at the base end-side overhang part, and a notch part that has been lowered in level by this removal is thus formed.

### CROSS-REFERENCE TO RELATED APPLICATIONS

This application claims priority to Japanese Patent Application No. 2010-110285, filed May 12, 2010, all of which is herein incorporated by reference in its entirety.

### FIELD OF THE INVENTION

The present disclosure relates to multi-way reversing valves, such as three-way reversing valves, four-way reversing valves, etc., used in refrigeration cycles (e.g., heat pumps) or the like, and, more particularly, to rotary multi-way reversing valves that reverse flow paths by rotating a valve member by means of an actuator, such as a motor, etc.

### BACKGROUND OF THE INVENTION

The assignee of the present application has previously proposed a multi-way reversing valve as that shown in FIG. 5 (see, for example, Patent Documents 1 and 2 mentioned below, the entire contents of each being herein incorporated by reference in their entirety). The illustrated multi-way reversing valve is briefly described below.

Multi-way reversing valve 10′ in the illustrated example is a rotary multi-way reversing valve (e.g., four-way reversing valve) for use in a heat pump device. The multi-way reversing valve 10′ generally uses a refrigerant for the fluid and includes a stepping motor 15 as a flow-path reversing actuator having a rotor 16 disposed on the inner-circumference side of a can 18 and a stator 17 that is externally fitted and fixed on the outer circumference of the can 18; a valve member 50 that is rotated by the stepping motor 15; and a valve housing 60 that rotatably holds this valve member 50.

It is noted that a planetary gear reduction system 40 is installed within the motor 15, and the rotation of the output shaft of the motor 15 (an output shaft 45 of the planetary gear reduction system 40) is transmitted to the valve member 50.

The valve housing 60 includes an upper box-like body (upper segment) 60A and a lower lid-like body (lower segment) 60B which are fastened in an airtight manner by means of three bolts 93. The upper box-like body 60A and the lower lid-like body 60B define a cylindrical valve chamber 61.

The upper box-like body 60A includes an upper base part 60a of a generally protruding shape, and a cylindrical wall part 60b that protrudes downward from the outer circumferential part of the lower surface of the upper base part 60a and that mainly defines a circumferential wall part of the valve chamber 61. A first in/out port 12 and a second in/out port 13, each having an inverted L-shaped section and comprising a horizontal hole and a vertical hole, are provided on the left and right of the upper base part 60a. Further, a low-pressure refrigerant outlet port 14 leading to the valve chamber 61 is provided on the front side of the upper part of the cylindrical wall part 60b.

On the other hand, the lower lid-like body 60B is arranged in the shape of a thick plate with a ledge and onto which the lower end part of the cylindrical wall part 60b is fitted. In the center thereof (along rotational axis line O) is provided a high-pressure refrigerant inlet port 11 which penetrates therethrough and opens into the valve chamber 61. It is noted that in order to reduce weight and so forth, aluminum is typically used for the material of the valve housing 60 (i.e., the upper box-like body 60A and the lower lid-like body 60B).

A valve seat member 65 is provided (screwed) at the ceiling part of the valve chamber 61. The respective lower end openings of the first in/out port 12 and the second in/out port 13 are formed in the valve seat member 65.

The valve member 50 includes a valve shaft member 50A made of stainless steel (SUS) comprising, in order from the top, a small-diameter shaft part 51 that is coupled with, in an integrally rotatable manner, the output shaft 45 of the planetary gear reduction system 40 within the motor 15, a center shaft part 52 inserted into a center hole 67 formed in the upper box-like body 60A and into an opening 69 formed in the center of the valve seat member 65, and a large-diameter cylindrical shaft part 53 inserted into the inlet port 11; and an off-axis member 54 that is externally fitted and fixed onto a ledge part of the valve shaft member 50A, the ledge part spanning from the lower end part of the center shaft part 52 located within the valve chamber 61 down to the upper end of a center thick-walled part 53a of the large-diameter cylindrical shaft part 53. The parts located within the valve chamber 61 (i.e., the lower part of the center shaft part 52, the large-diameter cylindrical shaft part 53, and the off-axis member 54) form a crank-shaped or inverted L-shaped reversing valve member part 50B.

The center shaft part 52 and the lower end part of the large-diameter cylindrical shaft part 53 of the valve shaft member 50A are respectively supported by sleeve-like shaft bearing members 86 and 87 in a slidable and rotatable fashion. Further, a Teflon (registered trademark) lip seal 83 is installed between the lower tapered surface part of the center thick-walled part 53a of the large-diameter cylindrical shaft part 53 and the inner circumferential surface of the inlet port 11.

A valve member internal passage 55 is provided within the reversing valve member part 50B, the valve member internal passage 55 being of a crank-shape or an inverted L-shape similar thereto.

At the exit-side end part of this valve member internal passage 55, an O-ring 74 and a square ring 75 as seal members are mounted so as to be in pressured contact with the valve seat member 65 in an airtight manner. The O-ring 74 is pressured radially outward by the high-pressure fluid flowing through the valve member internal passage 55, and its cross-section changes from circular to elliptical. Utilizing this change in shape of the O-ring 74, one end surface of the square ring 75 is pressed against the valve seat member 65 to attain a sealing effect.

It is noted that, in order to press the exit-side end part of the valve member internal passage 55 (i.e., the square ring 75) against the valve seat member 65, a coil spring 92 that biases the valve member 50 towards the valve seat member 65 is compressed and loaded around the outer circumference of a cylindrical protruding wall part 60d that is provided in a protruding manner at the center part of the upper surface of the lower lid-like body 60B. In addition, in order to prevent any unwanted fluid leakage, a seal member, such as an O-ring 95, etc., is mounted at key points, such as at interfaces between the various members, etc., for example, between the lower inner circumferential surface of the cylindrical wall part 60b of the upper box-like body 60A and the upper outer circumferential surface of the lower lid-like body 60B.

With the multi-way reversing valve (four-way reversing valve) 10′ having the configuration above, as is shown from FIG. 4A (a schematic reference view of the valve member 50 and the valve seat member 65 as viewed from below), as the valve member 50 is rotated by the motor 15, and the exit-side end part of the valve member internal passage 55 (i.e., the square ring 75) arrives at the position directly below (the lower end opening of) the first in/out port 12 of the valve seat member 65, the inlet port 11 and the first in/out port 12 are placed in communication with each other via the valve member internal passage 55. Thus, the high-temperature high-pressure refrigerant flows towards the first in/out port 12 via the valve member internal passage 55, while the low-temperature low-pressure refrigerant from the second in/out port 13 flows towards the outlet port 14 via the valve chamber 61 (e.g., a first circulation state of valve 10′).

Conversely, as the exit-side end part of the valve member internal passage 55 (i.e., the square ring 75) is rotated to the position directly below (the lower end opening of) the second in/out port 13 of the valve seat member 65, the inlet port 11 and the second in/out port 13 are placed in communication with each other via the valve member internal passage 55. Thus, the high-temperature high-pressure refrigerant flows towards the second in/out port 13 via the valve member internal passage 55, while the low-temperature low-pressure refrigerant from the first in/out port 12 flows towards the outlet port 14 via the valve chamber 61 (e.g., a second circulation state of valve 10′).

Thus, the multi-way reversing valve 10′ in the illustrated example reverses flow paths by rotating the valve member 50 to selectively place either the first in/out port 12 or the second in/out port 13 in communication with either the inlet port 11 or the outlet port 14 via the valve member internal passage 55 and the valve chamber 61. See, e.g., Patent Document 1 (JP Patent Application No. 2010-010309) and Patent Document 2 (JP Patent Application No. 2009-203926).

### SUMMARY OF THE INVENTION

As shown in FIG. 4A, the rotary four-way reversing valve 10′ mentioned above is such that rotational axis line O of the valve member 50 and center line C1 of the inlet port 11 substantially overlap with each other, and the first in/out port 12 and the second in/out port 13 are positioned symmetrically about center line C1. The respective offset amounts (distances between port centers) of center line C2 of the first in/out port 12 and center line C3 of the second in/out port 13 relative to center line C1 of the inlet port 11 are both La.

The valve member 50 of the four-way reversing valve 10′ comprises a laterally protruding part 54a for forming the crank-shaped or inverted L-shaped valve member internal passage 55, the laterally protruding part 54a protruding significantly outward in the radial direction (towards center lines C2 and C3 of the in/out ports 12 and 13) from rotational axis line O (center line C1 of the inlet port 11). In addition, there is provided a base end-side (rotational axis line O-side) overhang part 54 which protrudes in the opposite direction to the protruding direction of the laterally protruding part 54a, is semi-circular or semi-elliptical in plan view, and has the same thickness Ta as the laterally protruding part 54a (see FIG. 5). The base end-side overhang part 54b is required as a spring receiving part for the compression coil spring 92 that biases the valve member 50 towards the valve seat member 65.

However, as can be seen from the drawing, when the aforementioned offset amounts are of a relatively small value La as is the case in FIG. 4A, the base end-side overhang part 54b partially blocks the in/out port 13 in the first circulation state (the cross-hatched part in the drawing), while it partially blocks the first in/out port 12 in the second circulation state. Thus, there arises a problem in that refrigerant circulation between those in/out ports 12 and 13 and the valve member 61 is obstructed (although the drawing shows the first circulation state, the same applies to the second circulation state).

If the offset amounts were to be increased to Lb as shown in FIG. 4B in an attempt to prevent the problem above, not only would it lead to increases in the sizes of the valve seat member 65, the valve housing 60, and ultimately the four-way reversing valve 10′, but the moment acting on the valve member 50 would increase, thereby necessitating an even greater torque for flow path reversal, which would in turn lead to an increase in size for the motor, and so forth.

The present invention is made in view of the circumstances discussed above, and one object thereof is to provide a multi-way reversing valve that is capable of preventing the obstruction of fluid circulation between the in/out ports and the valve chamber without causing an increase in size.

In order to achieve the object above, a multi-way reversing valve according to an embodiment of the present invention includes a valve housing having a valve seat member in which a plurality of in/out ports are formed, and a valve chamber; a valve member adapted to be rotated in contact with the valve seat member; and an actuator adapted to rotationally actuate the valve member, wherein an inlet port and/or an outlet port open(s) into the valve chamber, a passage adapted to selectively place the inlet port or the outlet port in communication with the plurality of in/out ports is formed within the valve member, flow paths are reversed by rotating the valve member by means of the actuator to selectively place the inlet port or the outlet port in communication with one of the plurality of in/out ports via the passage within the valve member, the valve member is provided with a laterally protruding part that protrudes radially outward from a rotational axis line of the valve member in order to form the passage as well as with a base end-side overhang part that protrudes in the opposite direction to the protruding direction of the laterally protruding part, the base end-side overhang part being continuous with the laterally protruding part, and, in order not to obstruct fluid circulation between the in/out ports and the valve chamber and with the thickness and width of the laterally protruding part respectively being a reference thickness and a reference width, the base end-side overhang part is provided with a notch part so as to make the thickness and/or width of the base end-side overhang part respectively less than the reference thickness and/or the reference width.

In one specific preferred embodiment, with a surface of the laterally protruding part on the valve seat member-side as a reference surface, an amount corresponding to a predetermined thickness is removed from the reference surface at the base end-side overhang part, and the part that has been lowered in level by the removal is adapted to be the notch part.

In another specific preferred embodiment, as the notch part, there is formed a recessed part that is recessed inward from an outer circumferential surface of the base end-side overhang part on the valve seat member-side by an amount corresponding to a predetermined width, and that is recessed from a surface on the valve seat member-side by an amount corresponding to a predetermined thickness.

In another specific preferred embodiment, both outer circumferential side parts of the base end-side overhang part are removed by an amount corresponding to a predetermined width so as to make the width of the base end-side overhang part narrower than the reference width, and the parts that have been recessed by the removal are adapted to be the notch part.

In another preferred embodiment, respective surfaces of the laterally protruding part and the base end-side overhang part that are on the opposite side to the valve seat member-side are adapted to be flush with each other, and the flush surfaces are adapted to be a spring receiving surface for a coil spring that biases the valve member towards the valve seat member.

In another preferred embodiment, the rotational axis line of the valve member and a center line of the inlet port or the outlet port are adapted to substantially overlap with each other.

With a multi-way reversing valve according to an embodiment of the present disclosure, since the base end-side overhang part of the valve member is provided with the notch part in a certain arrangement, obstruction of refrigerant circulation between the in/out ports and the valve chamber can be prevented even if the offset amount were to be reduced, that is, without causing the multi-way reversing valve to increase in size. Thus, a sufficient refrigerant circulation amount may be secured, and thermal efficiency, etc., may be improved for a heat pump device, etc., in which the multi-way reversing valve is used.

### BRIEF DESCRIPTION OF THE DRAWINGS

FIGS. 1A and 1B show parts (a valve member and a valve seat member) of a first embodiment of a multi-way reversing valve according to the present disclosure, where FIG. 1A is a schematic view of the valve member and the valve seat member as viewed from the side, and FIG. 1B is a schematic view of the valve member and the valve seat member as viewed from below.

FIGS. 2A and 2B show parts (a valve member and a valve seat member) of a second embodiment of a multi-way reversing valve according to the present disclosure, where FIG. 2A is a schematic view of the valve member and the valve seat member as viewed from the side, and FIG. 2B is a schematic view of the valve member and the valve seat member as viewed from below.

FIGS. 3A and 3B show parts (a valve member and a valve seat member) of a third embodiment of a multi-way reversing valve according to the present disclosure, where FIG. 3A is a schematic view of the valve member and the valve seat member as viewed from the side, and FIG. 3B is a schematic view of the valve member and the valve seat member as viewed from below.

FIGS. 4A and 4B are views for illustrating problems of a multi-way reversing valve of a related example, and both are schematic views of a valve member and a valve seat member as viewed from below.

FIG. 5 is a vertical sectional view showing one example of a related multi-way reversing valve (four-way reversing valve).

### DETAILED DESCRIPTION OF THE INVENTION

Embodiments of multi-way reversing valves according to the present disclosure are described below with reference to the drawings.

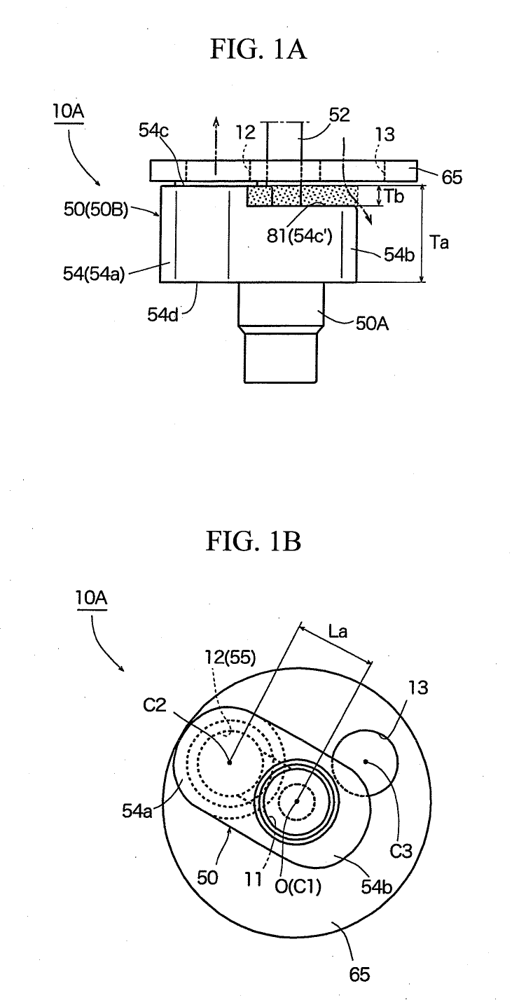

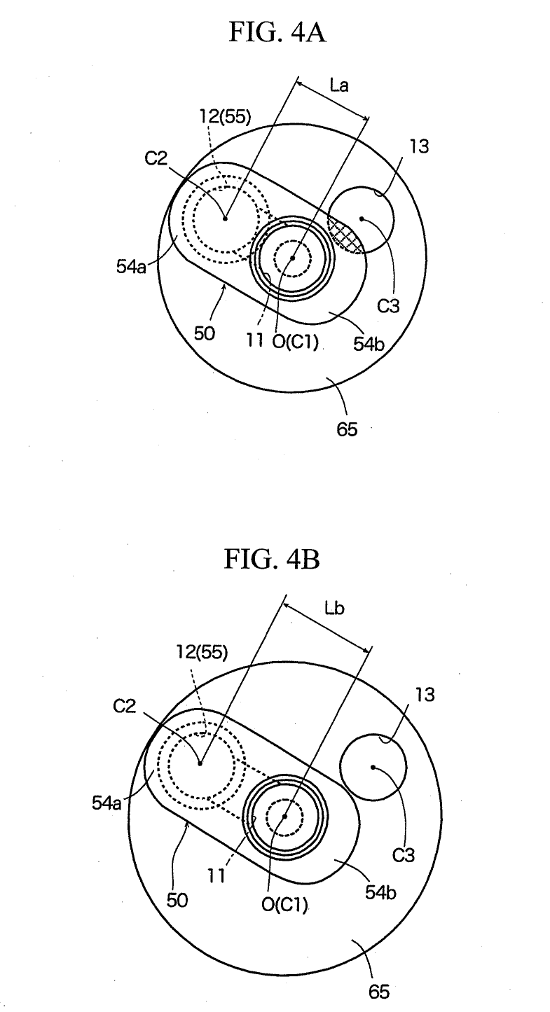

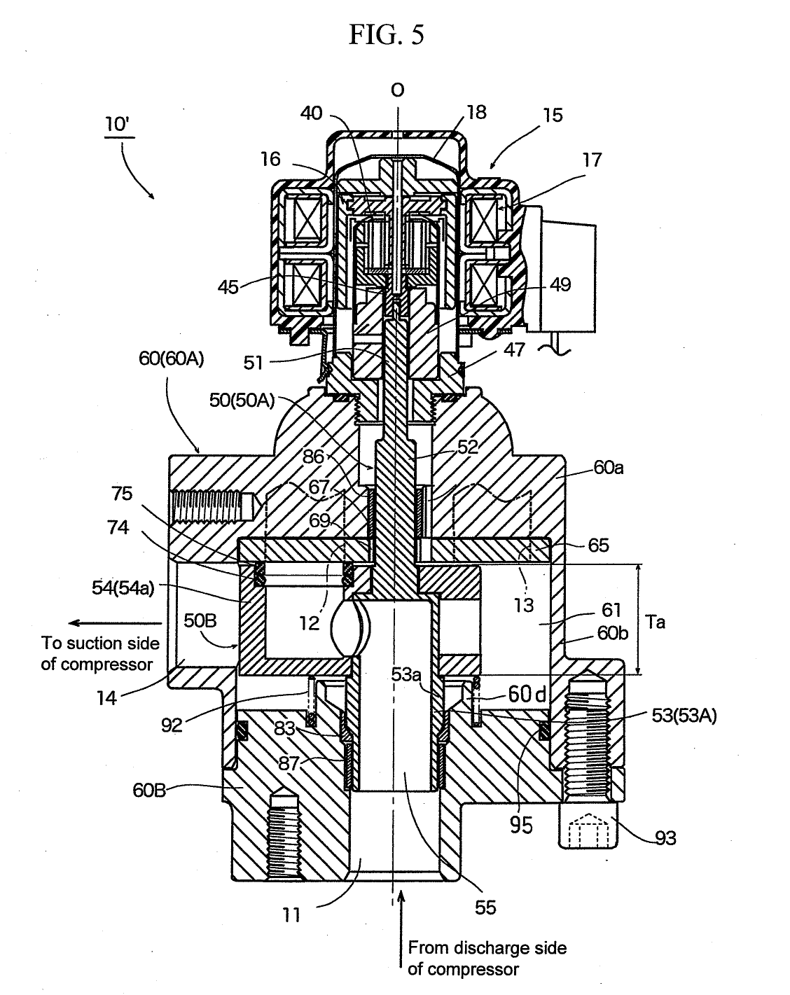

FIGS. 1A and 1B, FIGS. 2A and 2B, and FIGS. 3A and 3B respectively show parts (valve members and valve seat members) of the first, second, and third embodiments of four-way reversing valves as multi-way reversing valves according to the present disclosure. FIGS. 1A, 2A, and 3A are schematic views of the respective valve members and valve seat members as viewed from the side. FIGS. 1B, 2B, and 3B are schematic views of the respective valve members and valve seat members as viewed from below. Since four-way reversing valves 10A, 10B and 10C of the respective embodiments differ, inter alia, from the aforementioned four-way reversing valve 10′ shown in FIG. 5 and FIG. 4A in terms of the shape of the valve member 50, a description will be provided below with a focus on the shape of the valve member.

The valve member 50 of the four-way reversing valve 10A of the first embodiment shown in FIGS. 1A and 1B is provided with the laterally protruding part 54a as well as with the base end-side overhang part 54b. The laterally protruding part 54a protrudes significantly outward in the radial direction from rotational axis line O of the valve member 50 so as to form the passage 55. The base end-side overhang part 54b is continuous with the laterally protruding part 54a, protrudes in the opposite direction to the protruding direction of the laterally protruding part 54a, and is semi-circular or semi-elliptical in plan view. In order not to obstruct fluid circulation between the in/out ports 12 and 13 and the valve chamber 61 and with the thickness of the laterally protruding part 54a as reference thickness Ta, a notch part 81 is provided in the base end-side overhang part 54b so as to make the thickness thereof less than reference thickness Ta mentioned above.

More specifically, the surface of the laterally protruding part 54a on the valve seat member 65-side is taken to be a reference surface 54c, and an amount corresponding to predetermined thickness Tb (the part in FIG. 1A drawn with a stipple pattern) is removed from the reference surface 54c at the base end-side overhang part 54b. The part that has been lowered in level by this removal is adapted to be the notch part 81.

It is noted that, as in the related example mentioned above, the offset amount is La in the present embodiment as well, and a surface 54d on the opposite side to the valve seat member 65-side is adapted to be flush at the laterally protruding part 54a and the base end-side overhang part 54b. The flush surface 54d is adapted to be a spring receiving surface for the coil spring 92 that biases the valve member 50 towards the valve seat member 65.

Thus, with respect to the four-way reversing valve 10A of the first embodiment, the notch part 81 that is lowered in level from the reference surface 54c is provided in the base end-side overhang part 54b of the valve member 50. Accordingly, the separation distance between a surface 54c′ (the notch part 81) of the base end-side overhang part 54b on the valve seat member 65-side and the in/out ports 12 and 13 (the valve seat member 65) becomes significantly greater than that of the related example. Consequently, almost no obstruction occurs with respect to refrigerant circulation between the in/out ports 12 and 13 and the valve chamber 61 in either of the first and second circulation states.

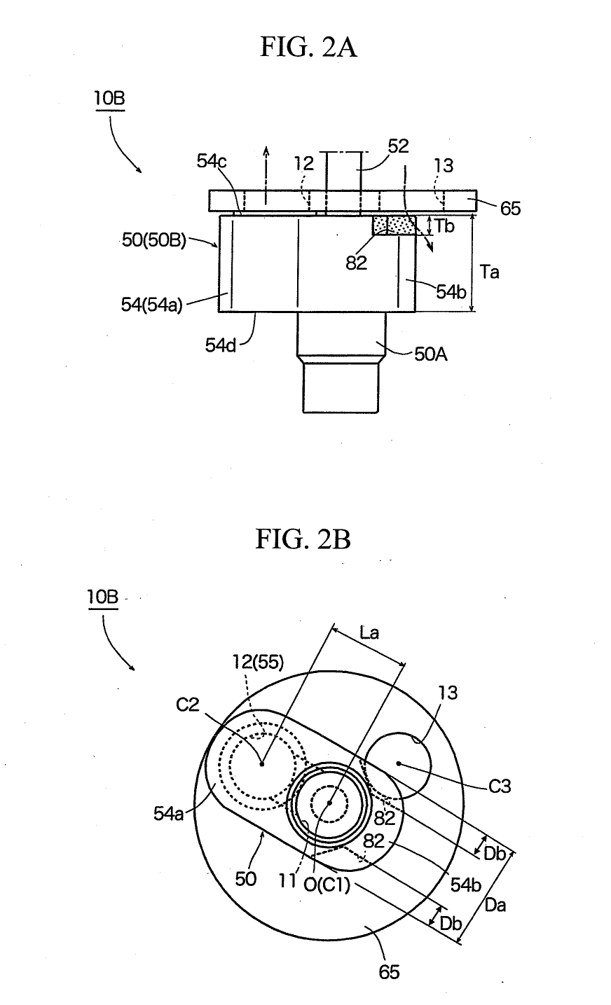

The valve member 50 of the four-way reversing valve 10B of the second embodiment shown in FIGS. 2A and 2B is such that, in order not to obstruct fluid circulation between the in/out ports 12 and 13 and the valve chamber 61 and with the thickness and width of the laterally protruding part 54a respectively taken to be reference thickness Ta and reference width Da, notch parts 82, 82 are provided in both the left- and right-side parts of the base end-side overhang part 54b on the valve seat member 65-side so as to make the thickness and width thereof respectively less than reference thickness Ta and reference width Da mentioned above.

More specifically, as the notch parts 82, 82, there are provided, at two locations on the left and right, recessed parts each comprising a wall surface that is generally V-shaped in plan view, where both the left and right side parts of the base end-side overhang part 54b on the valve seat member 65-side are recessed inward by an amount corresponding to predetermined width Db, and are also recessed from the surface on the valve seat member 65-side (i.e., the reference surface 54c) by predetermined thickness Tb.

Thus, with respect to the four-way reversing valve 10B of the second embodiment, the notch parts 82, 82 each comprising a recessed part that comprises a generally, in plan view, V-shaped wall surface are provided in the base end-side overhang part 54b of the valve member 50. Accordingly, as in the first embodiment, the in/out ports 12 and 13 no longer become blocked by the base end-side overhang part 54b in either of the first and second circulation states. Consequently, almost no obstruction occurs with respect to refrigerant circulation between the in/out ports 12 and 13 and the valve chamber 61.

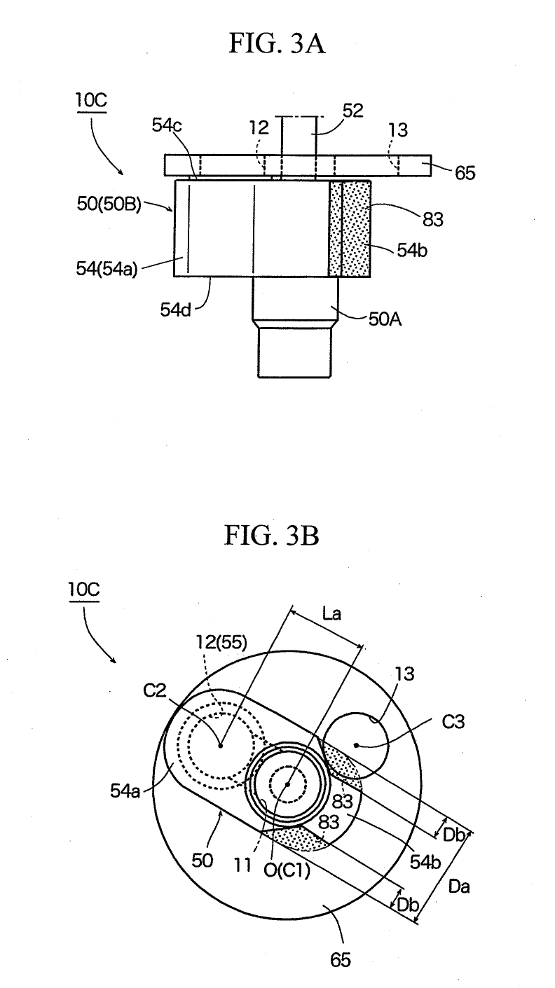

The valve member 50 of the four-way reversing valve 10C of the third embodiment shown in FIGS. 3A and 3B has notch parts 83, 83 provided in the base end-side overhang part 54b so as not to obstruct refrigerant circulation between the in/out ports 12 and 13 and the valve chamber 61.

More specifically, in order to make the width of the base end-side overhang part 54b narrower than reference width Da mentioned above, an amount corresponding to predetermined width Db is removed from both outer circumferential side parts thereof. The parts having a V-shape in plan view (at two locations, namely on the left and right) that have been recessed by this removal are adapted to be the notch parts 83, 83.

Thus, with respect to the four-way reversing valve 10C of the third embodiment, the notch parts 83, 83 each comprising a part having a V-shape in plan view are provided in the base end-side overhang part 54b of the valve member 50. Accordingly, as in the second embodiment, the in/out ports 12 and 13 no longer become blocked by the base end-side overhang part 54b in either of the first and second circulation states. Consequently, almost no obstruction occurs with respect to refrigerant circulation between the in/out ports 12 and 13 and the valve chamber 61.

Thus, with respect to the four-way reversing valves 10A, 10B and 10C of embodiments of the present disclosure, the respective notch parts 81, 82, 82, 83, 83 are provided in the base end-side overhang part 54b in certain arrangements. Accordingly, it is possible to prevent the obstruction of refrigerant circulation between the in/out ports 12 and 13 and the valve chamber 61 even when the offset amount is made to be of a small value La, that is, without causing the respective four-way reversing valves to increase in size. Consequently, sufficient refrigerant circulation amounts may be secured, and thermal efficiency, etc., may be improved for heat pump devices, etc., in which these four-way reversing valves are used.

It is noted that the present disclosure is by no means limited to the four-way reversing valves described above. For example, it is noted that the present disclosure is also applicable to three-way reversing valves as well as to reversing valves with five or more ports, etc.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

### DESCRIPTION OF FIGURE ELEMENTS

10 Multi-way reversing valve (four-way reversing valve)
11 Inlet port
12 First in/out port
13 Second in/out port
14 Outlet port
15 Motor (actuator)
50 Valve member
54a Laterally protruding part
54b Base end-side overhang part
55 Valve member internal passage
60 Valve housing
60A Upper body
60B Lower lid-like body
60C Cylindrical body
61 Valve chamber
65 Valve seat member
81, 82, 83 Notch part
92 Coil spring

What is claimed is:

1. A multi-way reversing valve comprising:
a valve housing having a valve seat member in which a plurality of in/out ports are formed, and a valve chamber;
a valve member adapted to be rotated in contact with the valve seat member; and
an actuator adapted to rotationally actuate the valve member;
wherein an inlet port and/or an outlet port open(s) into the valve chamber,
wherein a passage adapted to selectively place the inlet port or the outlet port in communication with the plurality of in/out ports is formed within the valve member;
wherein flow paths are reversed by rotating the valve member by means of the actuator to selectively place the inlet port or the outlet port in communication with one of the plurality of in/out ports via the passage within the valve member;
wherein the valve member is provided with a laterally protruding part that protrudes radially outward from a rotational axis line of the valve member in order to form the passage as well as with a base end-side overhang part that protrudes in the opposite direction to the protruding direction of the laterally protruding part, the base end-side overhang part being continuous with the laterally protruding part; and
wherein in order not to obstruct fluid circulation between the in/out ports and the valve chamber and with the thickness and width of the laterally protruding part respectively being a reference thickness and a reference width, the base end-side overhang part is provided with a notch part so as to make the thickness and/or width of the base end-side overhang part respectively less than the reference thickness or the reference width.

2. The multi-way reversing valve according to claim 1, wherein, with a surface of the laterally protruding part on the valve seat member-side as a reference surface, an amount corresponding to a predetermined thickness is removed from the reference surface at the base end-side overhang part, and a part that has been lowered in level by the removal is adapted to be the notch part.

3. The multi-way reversing valve according to claim 1, wherein, as the notch part, there is formed a recessed part that is recessed inward from an outer circumferential surface of the base end-side overhang part on the valve seat member-side by an amount corresponding to a predetermined width, and that is recessed from a surface on the valve seat member-side by an amount corresponding to a predetermined thickness.

4. The multi-way reversing valve according to claim 1, wherein both outer circumferential side parts of the base end-side overhang part are removed by an amount corresponding to a predetermined width so as to make the width of the base end-side overhang part narrower than the reference width, and parts that have been recessed by the removal are adapted to be the notch part.

5. The multi-way reversing valve according to claim 1, wherein respective surfaces of the laterally protruding part and the base end-side overhang part that are on the opposite side to the valve seat member-side are adapted to be flush with each other, and the flush surfaces are adapted to be a spring receiving surface for a coil spring that biases the valve member towards the valve seat member.

6. The multi-way reversing valve according to claim 1, wherein the rotational axis line of the valve member and a center line of the inlet port or the outlet port substantially overlap with each other.
